(19) United States
(12) Patent Application Publication
(10) Pub. No.: US 2026/0274722 A1
(43) Pub. Date: Sep. 17, 2026

(54) METHODS FOR CURTAILING BIOGENIC METHANE EMISSIONS USING PYROGENIC CARBON

(71) Applicant: UNIVERSITY OF DELAWARE, Newark, DE (US)

(72) Inventors: Pei Chiu, Middletown, DE (US); Danhui XIN, Newark, DE (US)

(73) Assignee: UNIVERSITY OF DELAWARE, Newark, DE (US)

(21) Appl. No.: 19/471,346

(22) PCT Filed: Mar. 28, 2024
(86) PCT No.: PCT/US2024/022050

§ 371 Date: Sep. 30, 2025

Related U.S. Application Data
(60) Provisional application No. 63/493,056, filed on Mar. 30, 2023.

(51) Int. Cl. C02F 3/00; B09B 3/65; C02F 3/28

(52) U.S. Cl. CPC C02F 3/006; B09B 3/65; C02F 3/28

(57) ABSTRACT

A method for reducing methane emitted from an anaerobic ecosystem comprising a microbial source prone to methanogenesis. The method comprising adding a quantity of pyrogenic carbon (PC), such as biochar, as a terminal electron acceptor to promote anaerobic respiration and suppress methanogenesis. In one embodiment, the biochar is added in at least a quantity corresponding to a ratio of unit weight PC for each mmol of methane otherwise expected to be produced and desired to be reduced from the anaerobic ecosystem, wherein the ratio equals A*0.125*ESC*BC per mol methane reduction, wherein: A=ESC bioavailability factor; ESC=electrons accepted in mol/unit weight; and BC=unit weight of BC.

### CROSS REFERENCE TO RELATED APPLICATIONS

This application claims priority to U.S. Provisional Application Ser. No. 63/493,056, titled PREVENTING BIOGENIC METHANE EMISSIONS USING OXIDIZED PYROGENIC CARBON, filed Mar. 30, 2023, incorporated by reference herein in its entirety for all purposes.

### BACKGROUND OF THE INVENTION

As Earth's population increases faces the challenges of global change, there is an increased need for technologies that can assist in sustainable food production while minimizing climate impacts. Rice is a staple food for half the global population, but its production under flooded paddy conditions promotes methane formation as well as arsenic accumulation in grain, necessitating solutions that both reduce methanogenesis and arsenic (As) uptake.

Methane (CH₄) is the second most important anthropogenic greenhouse gas (GHG). While its atmospheric concentration is only <0.5% that of CO₂, methane is a far more potent GHG on a per molecule basis, having a global warming potential 28 and 72 times that of CO₂ over 100 and 20 years, respectively. This means removing a molecule of methane is equivalent to removing dozens of molecules of CO₂ in reducing global warming.

In addition, because of the short lifetime of methane in the atmosphere (12 years vs. hundreds of years for CO₂), methane contributes to approximately one third of the current total GHG warming. Hence, while CO₂ remains utmost important in the long term, methane is disproportionally impactful in the short term. The high warming potency and short lifetime of methane combined represent a unique opportunity to rapidly reduce warming in the near term—by cutting methane emissions. Indeed, cutting methane emissions has been recognized as the single most important step we can take to reduce the rate of warming and avoid the most disastrous consequences of climate change in the short and medium terms.

In addition to mitigating global warming, cutting methane emissions can deliver a whole host of other benefits, including lower volatile organic compound and ozone concentrations in the atmosphere, and improved air quality and public and ecosystem health.

Methane is emitted from two major types of sources, each contributing to roughly half of the global emissions: (1) energy production facilities, including oil, gas, and coal mining facilities, and (2) anaerobic microbial systems, such as livestock, solid wastes, wastewater sludge, manure, and rice cultivation. For the latter, the source of methane is methanogens—a group of microbes that produce methane from acetate and other molecules. Bacteria in anaerobic systems are constantly competing with methanogens for food and other resources. For example, when there are abundant “electron acceptors”, bacteria can outcompete methanogens, and as a result, acetate is oxidized to CO₂ instead of converted into methane. This corresponds to a >96% decrease in GHG warming.

Annual global methane emissions are estimated to be 550-750 Tg, of which microbial methane production, i.e., methanogenesis, accounts for 90-95%. Methanogenesis, which is performed by methanogenic archaea (called methanogens) under strictly anaerobic conditions, is the last step of fermentation for degrading organic carbon. When electron acceptors exist, however, organic carbon can alternatively be degraded to CO₂ through anaerobic respiration. Acetate is fermented to produce equimolar amounts of methane and CO₂ (acetoclastic methanogenesis), whereas H2 is used to reduce CO₂ to CH₄ (hydrogenotrophic methanogenesis). In both cases, methane is the ultimate electron sink, possessing eight electrons from one molecule of acetate (eq 1) or four molecules of H₂ (eq 2):

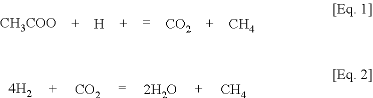

Given CH₄ and CO₂ are the two final products of anaerobic degradation, the presence of electron acceptors would shift the predominant pathway from fermentation to respiration, and therefore, suppress CH₄.

Pyrogenic black carbon is produced globally at the rate of 100 million tons per year, through either natural wildfire or anthropogenic processes such as deforestation and fossil fuel combustion. Research in recent years has shown that black carbon derived from biomass possesses a considerable electron storage capacity (ESC). Research further showed that microbes can respire black carbon through its ESC. That is, microbes can degrade organic carbon into CO₂ using black carbon as an electron acceptor. Given the ubiquity and abundance of black carbon in subsurface environments, black carbon may have significant climate impacts because it may serve as an electron storage medium to offer an alternative pathway to methanogenesis. In fact, methane suppression has been reported in burnt peatland sites following fire events.

The ESC of black carbon was first discovered in 2014. It has been reported that black carbon can serve as the sole electron acceptor to enable microbial oxidation of acetate to CO₂ using Geobacter metallireducens. The inventors' previous work further demonstrated that black carbon possesses a few mmol per gram of fully reversible and long-lasting ESC over multiple redox cycles. All these previous findings support that black carbon may be a huge, previously unrecognized rechargeable electron reservoir that can redirect the electron flow to suppress CH₄ production in subsurface environments, but such impact has not been experimentally proven.

Lower methane emissions have been observed in the presence of a terminal electron acceptor such as sulfate, ferric (oxyhydr)-oxides, and humic substances. Instead of methane being the electron sink, electrons are transferred by anaerobic bacteria to electron acceptors through respiration, which competes with and suppresses methanogenesis. This suggests that introducing an electron acceptor into a methanogenic system may be a viable strategy to reduce methane emissions.

The ESC of BC is believed to be composed of redox-facile functional groups such as (hydro) quinones, which are created through/during pyrolysis. Conceptually, ESC is the sum of the electron-donating capacity (EDC) and electron-accepting capacity (EAC). However, unlike EDC and EAC, which vary with the redox potential of the system, the ESC of a pyrogenic BC is constant when measured with a given pair of redox titrants. Note that, when EDC is zero (e.g., when O₂/air is used to remove all stored electrons in a PC), EAC and ESC are equal, and hence ESC can be determined by measuring EAC. The ESCs of BC derived from plants such as wood and grass and from plant constituents such as cellulose, hemicellulose, and lignin range from 0.5 to 7 mmol/g depending on the source biomass and pyrolysis conditions. Through silver tagging and microtomic imaging, it was confirmed that ESC is distributed not only at/near the surface but throughout the interior of BC particles. Studies also showed that microorganisms could partially access these ESC sites. For example, the bacterium Geobacter metallireducens could access 0.86 mmol/g, or ca. 22%, of the ESC of a wood biochar, using it as an electron donor to reduce nitrate when the ESC was electron-filled, or as an electron acceptor to oxidize acetate when the ESC was electron-depleted.

### SUMMARY OF THE INVENTION

One aspect of the invention relates to a method for reducing an amount of methane emitted from an anaerobic ecosystem comprising a microbial source prone to methanogenesis. The method comprises adding at least an effective quantity of pyrogenic carbon (PC) as a terminal electron acceptor to promote anaerobic respiration and suppress methanogenesis, the quantity comprising a ratio of at least 1 unit weight of PC for each mmol of CH₄ otherwise expected to be produced and desired to be reduced from the anaerobic ecosystem per redox cycle, based upon an electron storage capacity (ESC, in mmol/g PC) of the PC calculated as: A*0.125*ESC*M=mmol methane reduction per redox cycle, wherein: A=ESC bioavailability factor; ESC=measured ESC in mmol/unit weight; and M=weight of PC. In embodiments, the PC may comprise a biochar (BC), such as a wildfire char or any other plant-based (bio)char. In embodiments the anaerobic ecosystem may comprises a wastewater or sludge treatment facility, a manure management system, a landfill, a rice paddy, or a wetland.

Another aspect of the invention relates to a method for reducing an amount of methane emitted from an anaerobic ecosystem comprising a microbial source prone to methanogenesis. The method comprises the steps of determining an expected amount of CH₄ generated per unit mass of the anaerobic ecosystem; providing a source of biochar (BC); and determining the electron storage capacity (ESC) of the BC. Based upon the ESC of the BC, a mass ratio of BC to be added per unit mass of the anaerobic ecosystem as a terminal electron acceptor to achieve a desired percentage reduction in the expected amount of CH₄ generated per unit mass of the anaerobic ecosystem is determined, and the anaerobic ecosystem is treated with the BC in at least the determined mass ratio. In embodiments, the BC comprises a wildfire char. In embodiments the anaerobic ecosystem may comprises a wastewater or sludge treatment facility, a manure management system, a landfill, a rice paddy, or a wetland.

### BRIEF DESCRIPTION OF THE DRAWINGS

FIG. 1A is a graph depicting EAC measurement of SRB samples, showing cumulative oxidation of Ti(III) citrate by air-oxidized and biologically reduced SRB samples over time. Error bars represent the data range from duplicates.

FIG. 1B is a graph depicting EAC measurement of SRB samples, showing total amounts of Ti(III) consumed (i.e., electrons transferred) as a function of the SRB mass. Error bars represent the data range from duplicates.

FIG. 2A is a graph depicting CH₄ and CO₂ production during sludge incubation without SRB. Y-axis values represent the total masses of CH₄ and/or CO₂ in the reactors. Error bars represent one standard deviation based on triplicates.

FIG. 2B is a graph depicting CH₄ and CO₂ production during sludge incubation with 0.5 g of air-oxidized SRB. Y-axis values represent the total masses of CH₄ and/or CO₂ in the reactors. Error bars represent one standard deviation based on triplicates.

FIG. 2C is a graph depicting CH₄ and CO₂ production during sludge incubation with 1.0 g of air-oxidized SRB. Y-axis values represent the total masses of CH₄ and/or CO₂ in the reactors. Error bars represent one standard deviation based on triplicates.

FIG. 3A is a graph depicting CH₄ and CO₂ production during ¹³C-labeled acetate (¹³CH₃COO⁻) incubation without SRB.

FIG. 3B is a graph depicting CH₄ and CO₂ production during ¹³C-labeled acetate (¹³CH₃COO⁻) incubation with 0.5 g of air-oxidized SRB.

FIG. 3C is a graph depicting CH₄ and CO₂ production during ¹³C-labeled acetate (¹³CH₃COO⁻) incubation with 1.0 g of air-oxidized SRB. The y-axis values represent the total masses of CH₄ and/or CO₂ in reactors.

FIG. 3D is a graph depicting the CH₄-to-CO₂ mole ratios calculated from the panels in FIGS. 3A to 3C. Error bars represent one standard deviation based on quadruplicates.

FIG. 4A is a graph depicting ¹³CH₄ production during ¹³C-labeled acetate incubation with a sludge culture in the presence of 0, 0.5, or 1.0 g of air-oxidized SRB.

FIG. 4B is a graph depicting ¹³CO2 production during ¹³C-labeled acetate incubation with a sludge culture in the presence of 0, 0.5, or 1.0 g of air-oxidized SRB.

FIG. 5 is a table referred to as Table 1 herein.

FIG. 6 is an illustration of the carbon flow and electron flow in methanogenesis versus anaerobic respiration in the presence of carbon black.

FIG. 7 is an illustration of repeated methane reductions over time in a cyclical anaerobic ecosystem.

### DETAILED DESCRIPTION OF THE INVENTION

Aspects of the invention involve using a pyrogenic carbon (PC), such as biochar, to reduce methane emissions from microbial sources; e.g., wastewater and sludge treatment facilities, manure management systems, landfills, rice paddies, and wetlands. PC supports anaerobic bacteria, enabling them to outcompete methane-producing organisms in the aforementioned and similar systems.

Pyrogenic carbon (PC) is an electron acceptor that is ideally suited for cutting methane emissions from a broad range of microbial sources. PC produced from plant-based materials (wood, grass, cellulose, lignin, etc.)—also referred to herein as biochar (BC)—possesses a significant electron storage capacity (ESC) of between ~0.5 and ~7 millimoles per gram; that is, each gram of PC can store approximately one billion trillion electrons in its structure. The ESC of PC is microbially accessible. Just like we eat sugar and breathe oxygen (and transfer 24 electrons from one sugar molecule to oxygen), anaerobic bacteria can eat acetate and breathe oxidized PC (and transfer 8 electrons from one acetate molecule to PC). Just as oxygen is an electron acceptor to humans, PC is an electron acceptor to certain bacteria. When oxidized PC is added to a microbial system, acetate is preferentially degraded by bacteria, instead of by methanogens. As a result, methane production was greatly suppressed. Note that “oxidized PC” is simply PC exposed to an oxidizing agent such as atmospheric air. For example, in a tidal wetland that is cyclically covered and uncovered by water, the periodic exposure to atmospheric air is sufficient to regenerate the PC. Accordingly, treatments as described herein may be with PC, preferably BC, that has not been subjected to an oxidation treatment prior to use.

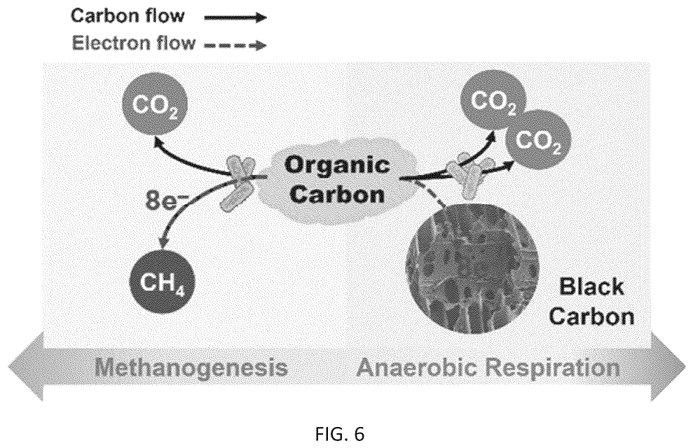

Without being held to a particular theory, it is believed that in the presence of black carbon, the predominant pathway of anaerobic organic carbon degradation shifts from fermentation toward respiration as depicted in FIG. 6, leading to a lower CH₄-to-CO₂ ratio. This hypothesis was tested in a synthetic binary microbial consortium with Methanosarcina barkeri and Geobacter metallireducens as model microbes for conducting methanogenesis and anaerobic respiration, respectively. Acetate was supplied in access as am electron donor, and air-oxidized (ESC-vacant) black carbon was added in different doses as electron acceptor. Reactors without black carbon and with reduced (ESC-saturated) black carbon were included as controls. The production of CH₄ and CO₂ was monitored over time to assess the rate of CH₄ production and CH₄-to-CO₂ ratio. M. barkeri and G. metallireducens were selected because (1) the two species co-exist ubiquitously and abundantly in anaerobic digesters, soils, and sediments, and have been co-cultured in literature; (2) M. barkeri is an acetoclastic methanogen that splits acetate into CH₄ and CO₂, whereas G. metallireducens is capable of oxidizing acetate to CO₂ by respiring black carbon.

PC such as biochar made from wood chips, grass, and other waste biomass, is a highly stable form of carbon. PC is believed to yield dual climate benefits/carbon credits, by sequestering stable carbon and by cutting methane emissions at the same time. PC prepared from waste biomass can be applied to natural systems such as wetlands and tidal marshes, engineered systems such as landfills and wastewater/sludge treatment plants, and agricultural systems such as animal manure facilities and rice paddies, all of which are listed by the U.S. EPA as major sources of methane.

The inventors have demonstrated a specific mechanism through which pyrogenic BC reduces microbial methane production. Through its ESC, BC can act as a terminal electron acceptor to enable anaerobic respiration and suppress methanogenesis. That is, electron flow through an anaerobic ecosystem can be diverted to BC instead of to methane. As discussed further herein, the inventors have quantified the portion of the ESC that is microbially utilizable in order to establish an electron balance. The inventors have also estimated the corresponding minimum reduction potential of the redox moieties in BC that could support anaerobic respiration. In addition, microbial communities with and without BC were compared through 16S rRNA gene amplicon sequencing and taxonomic analysis.

### Examples

### Materials and Methods

Chemicals. Solutions of sodium hydroxide (NaOH, 50%) and hydrochloric acid (HCl, 36.5-38%), potassium phosphate dibasic (K2HPO4, 99.4%), magnesium chloride hexahydrate (MgCl₂·6H2O, >99.0%), calcium chloride dihydrate (CaCl2·2H2O, >99.0%), and potassium chloride (KCl, >99.0%) were purchased from Fisher Scientific (Pittsburgh, PA). Sodium acetate-2-13C (13CH3COONa, 99% 13C atom) and ammonium chloride (NH4Cl, 99.5%) were obtained from Sigma-Aldrich (St. Louis, MO). Sodium phosphate monobasic dihydrate (NaH2PO4·2H2O, 99.5%) was acquired from J. T. Baker (Phillipsburg, NJ). Tween 80 (polysorbate 80) was obtained from Acros Organics (Morris Plains, NJ). Vitamin (MD-VS) and trace element (MD-TMS) solutions were purchased from American Type Culture Collection (ATCC, Manassas, VA) for microbial incubation. All chemicals were used as received.

Black Carbon. Soil Reef biochar (SRB), produced through pyrolysis of Southern Yellow wood chips at 550° C., was used as a model BC. SRB was chosen for the following reasons. (1) It has been used as a reference BC material to study the ESC of a broad spectrum of natural and manmade pyrogenic BC. (2) The size, reversibility, and distribution of the ESC in has been determined in previous studies. (3) The physical-chemical properties of SRB have been measured. (4) The percentage of SRB's ESC that is accessible to G. metallireducens has been reported. The portion accessible to mixed consortia, however, was unknown and was evaluated in this example to provide insight into how microbes access black carbon's ESC.

SRB was sieved to the 250-500 μm size fraction and used for all experiments. To eliminate residual electrons (i.e., to oxidize reduced functional groups in SRB) and hence maximize the electron-accepting capacity, SRB was oxidized in continuously aerated, dissolved 02-saturated deionized water (EH=+0.80 V vs the standard hydrogen electrode, or SHE, pH 7.0±0.5, PO=0.21 atm) for 10 days. pH of the aerated water was controlled through dropwise addition of H2SO4. The oxidized SRB was vacuum-filtered, dried at 60° C., placed under vacuum overnight, and then transferred to an anaerobic glovebox (Coy Laboratory, Grass Lake, MI) under 98 #0.5% N2 and 2.0±0.5% H2 (PO<5 ppm). The SRB was stored in the glovebox for 10 days to eliminate any residual sorbed O2.

Culture. Activated sludge was collected from the secondary treatment tank of Aberdeen Advanced Wastewater Treatment Plant in Aberdeen, MD. The activated sludge had a total suspended solid of 23.27±0.05 g/L, an optical density at 600 nm (OD600) of 1.80, a dissolved organic carbon of 72.2±4.2 mg/L after filtration with a 0.22 μm PVDF filter, and a pH of 6.60±0.17. The sludge was collected in a sealed glass bottle without a headspace and stored at 4° C. Twenty-four hours prior to use, the sludge was placed in an incubator at 30° C. for preactivation, mixed, and used as a seed culture.

EAC Measurement. The EACs of air-oxidized and deoxygenated SRB and SRB samples collected at the end of an acetate incubation experiment (described below) were measured through chemical redox titration using titanium (III) citrate (−0.36 V vs SHE at pH 6.4) as a reductant, following the method established by Xin et al. “Pyrolysis Creates Electron Storage Capacity of Black Carbon (Biochar) from Lignocellulosic Biomass. ACS Sustain Chem. Eng. 2021, 9 (19), 6821-6831 and Saha, et al., “Effect of Pyrolysis Temperature on Acidic Oxygen-Containing Functional Groups and Electron Storage Capacities of Pyrolyzed Hydrochars.” ACS Sustain Chem. Eng. 2019, 7 (9), 8387-8396, both of which are incorporated herein by reference. Briefly, EAC was determined based on cumulative oxidation of Ti(III) by SRB, as measured by UV-vis absorption at 400 nm. For air-oxidized SRB, the EAC was taken to be the ESC of the SRB for the EH range of −0.36 to +0.80 V vs SHE; i.e., in the EH range between the Ti(IV)/Ti(III) and O2/H2O redox couples. EAC measurements were repeated using different masses of air-oxidized SRB in duplicate with the control (without SRB) to ensure that the ESC of SRB was constant and independent of the char mass used.

More detailed information regarding exemplary measurement techniques for EAC can be found below.

### EAC Measurement Using Ti(III) Citrate

Ti(III) citrate concentration was first standardized by benzoquinone of high purity. Each EAC measurement was performed in duplicates, and reactors without SRB were used as control for all experiments. A known mass of pre-oxidized SRB was added to 0.50 L of 10 mM Ti(III) in 100 mM sodium citrate at pH 6.4±0.2, the third pKa of citric acid. The anionic citrate buffer (50 mM each being doubly and triply negatively charged) was used to prevent sorption of Ti(III) citrate. Preliminary tests showed that aqueous Ti(III) concentration was constant for 24 h in the presence of dithionite-reduced SRB. In addition, the total Ti concentration in solution remained constant as Ti(III) citrate was consumed following addition of oxidized SRB. This confirms that neither Ti(III) nor Ti(IV) sorbed to biochar during EAC measurement, and hence Ti(III) consumption could be attributed to oxidation by SRB. Reactors were placed on an orbital shaker at 100 rpm. At different elapsed times, 6.6-mL samples were collected and passed through a 0.22 μm PVDF syringe filter for Ti(III) analysis.

The electrons transferred to SRB from Ti(III) was calculated based on electron balance using the following equation E1:

$$e - transferred ( mmol ) = {C}_{1} \times {V}_{1} - {C}_{n} \times ( {V}_{1} - {nV}_{1} ) - {\sum }_{t = 1}^{n} ( {C}_{i} \times {V}_{i} ) \qquad [ Eq . E1 ]$$

where C₁ and V₁ are the initial Ti(III) concentration and solution volume, respectively, n is the total number of samples, Cn is the final Ti(III) concentration at equilibrium, and Ci and Vi are the Ti(III) concentration and volume of the i^{th} sample, respectively. That is, the number of electrons accepted by SRB was taken to be the difference between the initial and final electron contents of the Ti(III) citrate solution minus the electrons contained in all the samples withdrawn, which collectively accounted for <10% of the initial electron content of the Ti(III) solution. SRB was taken to be at equilibrium with solution when the change in EAC calculated from the foregoing equation E1 between two consecutive samples was <3%.

### EAC Measurement Using Dithionite/DCPIP

We measured the EAC of SRB using dithionite as a reductant for two reasons. First, dithionite is a strong and one of the most widely investigated reductant for environmental applications. Second, dithionite was used to reduce SRB which could then provide 0.87 mmol e-/g for microbial nitrate reduction. We developed a method using DCPIP to quantify the electron content of dithionite solution, instead of measuring dithionite itself. This was necessary because (1) the purity of commercial dithionite is low (~85%), (2) dithionite is unstable in solution and homolyzes to sulfoxyl radical (•SO2-) and disproportionates to thiosulfate and sulfite, and (3) unlike Ti(III) and Fe(III), which transfers one electron, the number of electrons transferred per dithionite (where S redox state=+3) depends on the products formed: e.g., thiosulfate (+2), sulfite (+4), or sulfate (+6). Dithionite and its daughter reductants can be oxidized by DCPIP (Eₕ°=+0.25 V at pH 7.0), 17 which can be measured spectrophotometrically. As SRB was reduced in dithionite solution, solution electron content was measured based on changes in DCPIP absorbance at 603 nm over time, and the EAC of SRB was calculated from the initial and final (i.e., equilibrium) solution electron contents.

A known mass of air-oxidized SRB was added to 0.20 L of 5 mM dithionite solution in 50 mM citrate buffer (pH 6.4±0.2). Reactors were shaken at 100 rpm and at different times 1-mL samples were removed, filtered, and analyzed with DCPIP. Briefly, 2 mL of 10 mM DCPIP was mixed with 1-mL dithionite sample, diluted to 10 mL, allowed to react for 1 h, and 20-fold diluted for DCPIP analysis. EAC was calculated using Eq.1.

The SRB sample (that had been microbially reduced) retrieved at the end of the acetate experiment was thoroughly washed with Tween 80 before its EAC was measured with Ti(III) citrate. Validation of the washing procedure with Tween 80 is detailed in Section S1 of the Supporting Information. Briefly, microbially reduced SRB was placed in anoxic 1% Tween 80 solution on an orbital shaker at 300 rpm for 20 min to remove cells and biomolecules that were attached to SRB and could potentially bias the EAC measurement. The control showed that the 1% Tween 80 treatment did not alter the measured EAC relative to virgin SRB.

Sludge Incubation Experiment. A sludge incubation experiment was conducted in 155 mL serum bottles. Four sets of reactors were prepared in sextuplicate: with no SRB, 0.5 g of SRB, and 1.0 g of SRB, plus a medium blank (no SRB or sludge). For the first three sets of reactors, each bottle received 48 mL of an aqueous solution consisting of 30 mL of sludge, 12 mL of 4× concentrated basal medium, and 6 mL of deionized water. The blank received 12 mL of a concentrated basal medium and 36 mL of deionized water. The basal medium included 30 mM phosphate buffer to help maintain the solution pH at 6.50±0.30 throughout the incubation and across treatments. The final solution contained 0.400 g/L MgCl2·6H2O, 0.113 g/L CaCl2·2H2O, 0.027 g/L NH4Cl, 2.971 g/L KH2PO4·H2O, 1.908 g/L Na2HPO4·2H2O, 1 mL/L MD-VS vitamin solution, and 1 mL/L MD-TMS trace mineral solution.

All reactors were prepared in an anaerobic glovebox. All solutions except sludge were either autoclaved at 121° C. before being transferred into the glovebox or sterilized using 0.22 μm PTFE filters inside the glovebox. All other materials were autoclaved before use. Each reactor was sealed with a rubber stopper and an aluminum crimp cap, removed from the glovebox, and flushed with high-purity N2 for 3 min at a flow rate of 7 L/min to remove any H2 carried over from the glovebox. All reactors were wrapped with aluminum foil and stored in an incubator (Heratherm, Thermo Fisher Scientific, Waltham, MA) at 30° C. for 20 days. Reactors were removed from the incubator at different times, and 50 μL gas samples were withdrawn from the headspace using a gastight syringe and immediately analyzed for CH₄ and CO₂ using a gas chromatograph-mass spectrometer (GC-MS, 6890-5973N, Agilent, Santa Clara, CA). For each sampling event, three reactors were randomly chosen from the sextuplicates for analysis.

¹³C-Acetate Incubation Experiment. A second incubation experiment was conducted with sodium acetate-2-¹³C (¹³CH₃COONa) as the main substrate. The same (155 mL) serum bottles were used to prepare five sets of reactors in quadruplicates: with no SRB, 0.5 g of SRB, and 1.0 g of SRB, plus the control (sludge only, no SRB or acetate) and medium blank (no SRB, acetate, or sludge). For the first three sets of reactors, each serum bottle received 60 mL of solution consisting of 3 mL of sludge, 12 mL of 25 mM acetate, 15 mL of 4× concentrated basal medium, and 30 mL of deionized water. For the sludge-only control and medium blank, 12 and 15 mL of deionized water were added, respectively, in place of acetate and sludge. The composition and pH (6.50) of the medium were the same as those in the sludge incubation experiment. All reactors were placed in an incubator at 30° C. for 30 days and sampled at different elapsed times for ¹²CH₄, ¹³CH₄, ¹²CO₂, and ¹³CO₂ using a GC-MS.

GC-MS Analysis. Fifty μL of gas sample was withdrawn from the headspace of reactors using a 250 μL gastight syringe equipped with a Mininert valve and a side port needle. The GC-MS was equipped with an Agilent 19091P-Q03 column (15 m×20 μm) with grade 5 helium as the carrier gas at 1.6 mL/min. The injector and oven temperatures were constant at 250 and 35° C., respectively. The total run time was 1 min, and the retention times of CH₄ and CO₂ were 0.53 and 0.79 min, respectively.

The MS was run in selective ion monitoring mode. Five ions were monitored for all analyses: m/z=12, 15, 17, 44, and 45. Gas-phase concentrations of ¹³CH₄, ¹²CH₄, ¹³CO₂, and ¹²CO₂ were determined based on total integrated ion abundance: ¹²CH₄ was confirmed based on m/z=12, ¹²CH₄ and ¹³CH₄ were quantified based on m/z=15 and 17, and ¹²CO₂ and ¹³CO₂ were quantified based on m/z=44 and 45, respectively. Grade 5 ¹²CH₄ and ¹²CO₂ and 99% 13C purity ¹³CH₄ and ¹³CO₂ (Millipore Sigma, Burlington, MA) were used as calibration standards. The total masses of CH4, CO2, ¹³CH₄, and ¹³CO₂ in an entire reactor were calculated from the measured headspace concentrations using the Henry's law constants of CH4 and CO2 and the pKas of dissolved CO2, as described below.

Assuming the gas and liquid phases were at equilibrium at room temperature, the amount of CH₄ or CO₂ in the aqueous phase ( [symbol] in mol) can be calculated (Eq. 3):

$$\text{?} \qquad [ Eq . 3 ]$$

$$\text{?} \text{indicates text missing or illegible when filed}$$

where H_{C} is Henry's law constant for CH₄ (714 atm·L/mol) and CO₂ (31.6 atm·L/mol), and V_{aq} was 0.045 L for the sludge experiment and 0.060 L for the acetate experiment.
The total mass of CH₄ in each reactor was thus:

$$\text{?} \qquad [ Eq . 4 ]$$

$$\text{?} \text{indicates text missing or illegible when filed}$$

The total CO₂ in solution was the sum of dissolved CO₂ (pKₐ₁ 6.3), bicarbonate (HCO₃⁻, pKₐ₂ 10.3), and carbonate (CO₃²⁻), calculated using Eq. 5:

$$\text{?} \qquad [ Eq . 5 ]$$

$$\text{?} \text{indicates text missing or illegible when filed}$$

where pH is 6.50 for both experiments.
The total mass of CO₂ in each reactor can thus be calculated based on Eq. 6:

$$\text{?} \qquad [ Eq . 6 ]$$

$$\text{?} \text{indicates text missing or illegible when filed}$$

Microbial Community Analysis. Aqueous and/or solid (SRB) samples were collected from the seed sludge and the no-SRB and 1g-SRB reactors at the end of an acetate incubation experiment. The samples were sent to the University of Delaware (UD) Sequencing and Genotyping Center for DNA extraction, high-throughput DNA sequencing, and 16S rRNA gene library construction. DNA was extracted using a Zymo Quick-DNA fungal/bacterial miniprep kit (Zymo Research, Irvine, CA). The primer pair 341F (CCTACGGGNGGCWGCAG)-805R (GACTACHVGGG-TATCTAATCC) was used to target the V3/V4 regions of the 16S rRNA of both bacteria and archaea. Library preparation was performed using a Nextera XT DNA Library Prep Kit (Illumina, San Diego, CA). The Illumina MiSeq platform was used for sequencing the library by 300 base paired-end sequencing. The DNA sequences were then sent to UD Bioinformatics Data Science Core Facility for community analysis using QIIME2 (ver 2023.7).36 Sequence data was demultiplexed and quality filtered in QIIME2 followed by denoising and clustering of data into amplicon sequence variants performed in DADA2 (ver 1.18.0). Taxonomy was assigned to amplicon sequence variants (ASVs) using QIIME2 classifier against the SILVA database (ver 138).

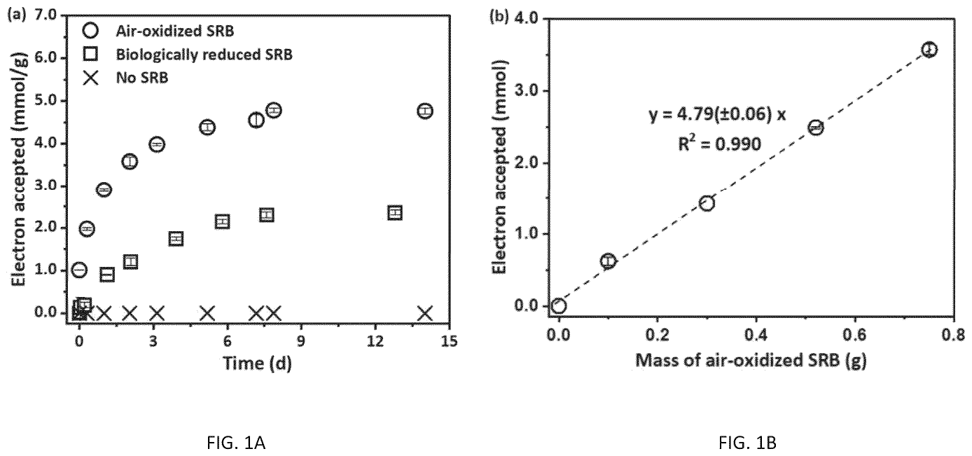

ESC Measurement. Prior to use in experiments, the ESC of the SRB was measured through chemical redox titration using Ti(III) citrate. As shown in FIG. 1A, the total amount of Ti(III) consumed by fully air-oxidized SRB plateaued in ca. 8 days and remained constant thereafter, indicating that all its reducible EAC had been filled, i.e., all redox-facile functional groups in SRB that could be reduced by Ti(III) citrate had been reduced. This gives an EAC of 4.81 mmol of electrons per gram, which was taken to be the ESC of the SRB (FIG. 1A). Repeating the ESC measurement using different masses of SRB yielded a linear relationship between the SRB mass and total Ti(III) consumed (FIG. 1B). The ESC of SRB determined from the slope was 4.79±0.06 mmol/g. Note that it took days for Ti(III) citrate to completely reduce SRB because most of the ESC (i.e., most of the redox-facile functional groups) resides in the interior of the particles and the kinetics of the process was pore diffusion-controlled. We air-oxidized SRB for 10 days for the same reason.

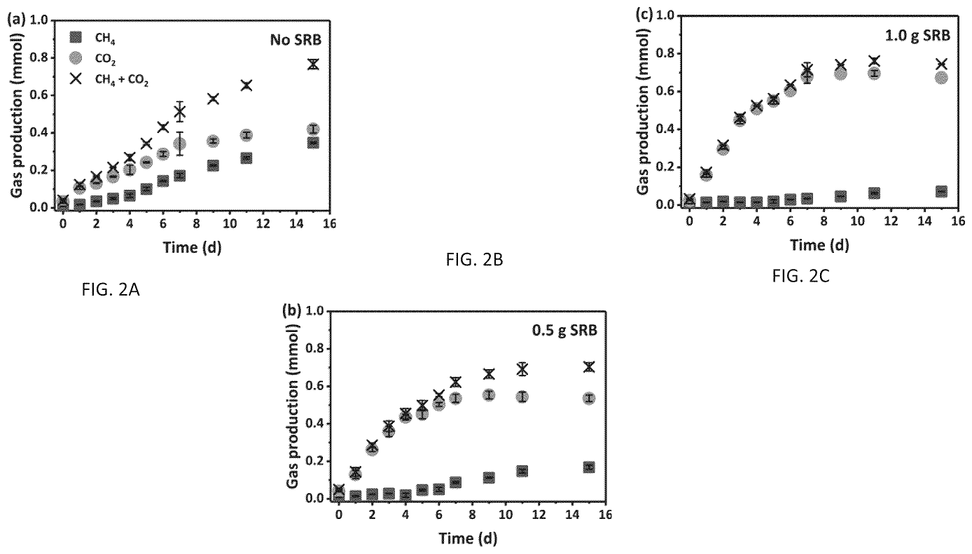

Sludge Experiment. The results of the sludge incubation experiment are shown in FIGS. 2A-2C. In the absence of SRB, organic carbon in the sludge was converted into CO₂ and CH₄ through a combination of fermentation and anaerobic oxidation (FIG. 2A). While more CO₂ was produced in early times, similar molar quantities of CO₂ and CH₄ were formed at the end of the 15 day period. A different picture emerged in the presence of 0.5 g of oxidized SRB (FIG. 2B): CO₂ appeared immediately and predominated throughout the incubation, suggesting that most of the organic carbon in the sludge was anaerobically oxidized. CH₄ did not appear until day 5, presumably after the terminal electron acceptors in the system had been largely depleted. The final CH₄ yield was lower by more than 50%, from 0.35±0.004 (FIG. 2A) to 0.17±0.01 mmol (FIG. 2B). The contrast was even more stark with 1.0 g of SRB (FIG. 2C), where CO₂ was almost the exclusive product. CH₄ did not appear until day 9 and accumulated to only 0.07±0.02 mmol.

These results clearly demonstrate that oxidized SRB can suppress methanogenesis, presumably by serving as an electron acceptor to enable anaerobic oxidation of the organic carbon in the sludge. Note that the total gas formed (CH₄+CO₂) in all reactors at the end of the incubation was relatively constant (0.77±0.05 mmol, FIGS. 2A-2C), indicating that CO₂ was produced at the expense of CH₄. As shown in FIGS. 2B, 2C the microorganisms that respired SRB could do so without a lag, immediately outcompeting the methanogens. Since CH₄ contains all the electrons from acetate or H2 (eqs 1 and 2), the results suggest that oxidized SRB redirected the electron flow away from methanogenesis by supporting anaerobic oxidation of acetate, H2, and/or other CH₄ precursors.

Saquing et al. (2016) showed that SRB could serve as a terminal electron acceptor for the oxidation of acetate by G. metallireducens. They also reported that each gram of SRB could accept 0.86 mmol of electrons to support acetate oxidation. Our results suggest that the ability to use pyrogenic BC as an electron acceptor is not unique to G. metallireducens but is likely common in anaerobic microbial communities. The CO₂ formation data also suggest that the EAC of SRB was readily utilized, and hence, the enzymes involved in BC respiration were presumably constitutive in this culture.

Given the unknown and complex nature of the organic carbon in sludge, it was not possible to establish an electron balance for the data in FIGS. 2A-2C. To that end and to confirm the results of the sludge experiment, we performed another experiment using 13C-labeled acetate (¹³CH₃COO⁻) as the predominant substrate/electron donor, with the same sludge as the seed culture (5%, v/v).

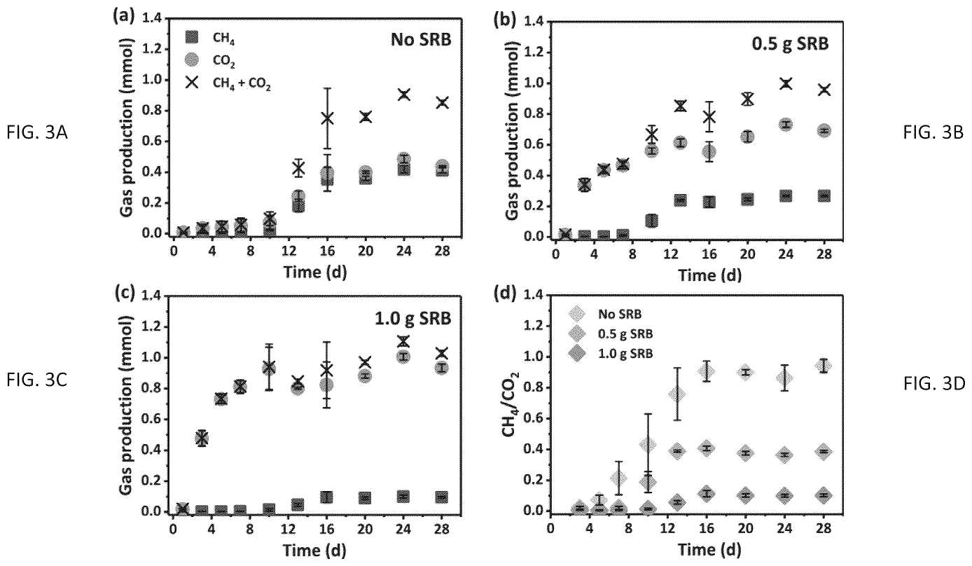

Acetate Experiment. FIGS. 3A-3D illustrate the results of the acetate incubation experiment. As expected from eq 1, approximately equimolar amounts of CH₄ and CO₂ were produced through acetate fermentation in the absence of SRB (FIG. 3A). With 0.5 g of oxidized SRB, CO₂ was the only gas product during the first week and CH₄ did not appear until day 10. For the rest of the incubation, CH₄ and CO₂ were again produced in roughly equimolar quantities (FIG. 3B). These results confirm that (1) the microbes in the sludge could use SRB as an electron acceptor for acetate oxidation, (2) the SRB-respiring microorganisms immediately dominated and out-competed methanogens, and (3) methanogens could start fermenting acetate only after acetate oxidation slowed, presumably because the available EAC of SRB had been largely depleted. With 1.0 g of oxidized SRB, CO₂ was almost the exclusive gaseous product throughout the incubation (FIG. 3C), as in the sludge experiment (FIG. 2C). CH₄ did not appear until day 13, and its mass never exceeded 0.08±0.01 mmol.

The CH₄-to-CO₂ mole ratios were calculated from FIGS. 3A-3C and used as an indicator of the extent of acetate fermentation (CH₄:CO₂=1) relative to the extent of acetate oxidation (CH₄:CO₂=0). In the absence of SRB, the increasing CH₄-to-CO₂ ratio in early times and the final value (0.94±0.04) being slightly below 1 suggest the presence of small amounts of electron acceptors (e.g., nitrate) in the wastewater sludge that supported acetate oxidation. With 0.5 and 1.0 g of SRB, the CH₄-to-CO₂ ratio decreased to 0.38±0.01 and 0.10±0.01, respectively, clearly indicating shifts in electron flow from acetate fermentation to anaerobic oxidation.

16S rRNA gene amplicon sequencing analysis was consistent with the chemical data in FIGS. 3A-3D and supports the CH₄-suppressing role of SRB. The analysis showed domain- and order-level relative abundance of the microbial communities, as well as the genus-level relative abundance of the archaeal communities, in the seed sludge and in acetate reactors with and without SRB. Sludge collected from the aeration basin contained few archaea (and hence few methanogens). The archaeal relative abundance grew markedly from 0.076 to 5.323% after fermentation of acetate to CH₄ and CO₂ (FIG. 3A) by acetoclastic methanogens. In contrast, in the presence of 1.0 g of oxidized SRB, archaeal abundance increased negligibly in both the liquid and solid phases, consistent with minimal CH₄ production and dominant acetate oxidation to CO₂ (FIG. 3C). The increase in archaeal relative abundance in the absence of SRB was accounted for almost entirely by Methanosarciniales (2.408%) and Methanobacteriales (2.748%), with Methanomas-siliicoccales, Methanofastidiosale, and Methanomicrobiales con-tributing to the rest (0.167%). With 1.0 g of SRB, again, little increase in methanogen abundance was observed except for that of Methanosarciniales, which increased from 0.016 to 0.4% in the liquid phase. A few orders of bacteria (e.g., Spirochaetales and Geobacterales) exhibited a marked increase in relative abundance due to SRB addition. These organisms are candidates for future studies as they may be involved in the (direct or indirect) respiration of black carbon.

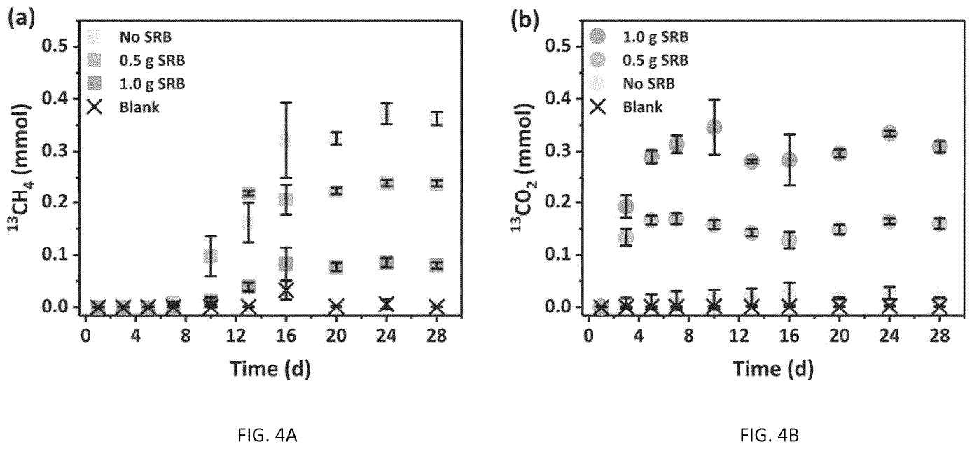

The formation of ¹³C-labeled gases provides further insights into the fate of acetate (FIGS. 4A-4B). Since only the methyl carbon of acetate was 13C-labeled, virtually all CH₄ and CO₂ produced in the absence of SRB were ¹³CH₄ (FIG. 4A) and ¹²CO₂, according to equation 7. Traces of ¹³CO₂ were formed (FIG. 4B) via acetate oxidation due to small amounts of electron acceptors in the sludge, as noted earlier. With 0.5 and 1.0 g of SRB, production of ¹³CH₄ decreased (FIG. 4A) and correspondingly the amounts of ¹³CO₂ produced increased (FIG. 4B), as shown in equation 8. These results support that, as an electron acceptor, SRB shifted the major acetate degradation pathway from fermentation to respiration (of SRB). The amount of ¹³CO₂ produced thus represents the electrons diverted to, and the amount of ¹³CH₄ formation prevented by, SRB.

$${}^{13} {CH}_{3} COOH \to {}^{13} {CH}_{4} + {}^{12} {CO}_{2} \qquad [ Eq . 7 ]$$

$${}^{13} {CH}_{3} COOH + 8 C = {O}_{( quinone in SRB )} + 2 {H}_{2} O \to 8 C - {OH}_{( hydroquinone in SRB )} {+}^{13} {CO}_{2} + {}^{12} {CO}_{2} \qquad [ Eq . 8 ]$$

$${}^{13} {CH}_{3} COOH + 2 {H}_{2} O \to {}^{13} {CO}_{2} + {}^{12} {CO}_{2} + 8 {e}^{-} + 8 {H}^{+} \qquad [ Eq . 8 a ]$$

$$8 C = {O}_{( quinone in SRB )} + 8 {e}^{-} + 8 {H}^{+} \to 8 C - {OH}_{( hydroquinone in SRB )} \qquad [ Eq . 8 b ]$$

To confirm that in both experiments (FIGS. 2A-3C and 3A-3D), SRB prevented CH₄ production rather than enabling CH₄ oxidation after it was produced, additional experiments using ¹³CH₄ as a substrate under the same conditions as for the acetate experiment were conducted. Neither ¹³CH₄ consumption nor ¹³CO₂ production occurred for 15 days, confirming that ¹³CH₃COO⁻ and other organic carbons in the sludge were directly oxidized by SRB respirers, which deprived methanogens of available substrates. CH₄-oxidizing BC-respirers, if existed, were either dormant or few in this culture.

The EAC of SRB that was utilized by the sludge culture can be estimated from the data in FIGS. 4A-4B. With increasing SRB mass, the ¹³CH₄ yield decreased from 0.36±0.04 to 0.23±0.02 and then 0.08±0.02 mmol, whereas the ¹³CO₂ yield increased from 0.02±0.01 to 0.15±0.02 and then 0.31±0.03 mmol. Hence, the available EAC in 1.0 g of oxidized SRB converted 0.28±0.03 mmol of CH₄ into CO₂. Given that eight electrons are involved in oxidizing CH₄ to CO₂, the EAC of SRB utilized by the culture was 2.24±0.24 mmol/g. Also, given that the total ESC of the SRB was 4.79 mmol/g, approximately half (47±5%) of this capacity was utilized by the sludge culture for acetate oxidation.

To confirm this result and to close the electron balance, SRB samples were collected at the end of the acetate incubation experiment, treated with anoxic Tween 80 solution, and subjected to EAC analysis. As shown in FIG. 1A, the “used” SRB recovered from the acetate incubation had an EAC of only 2.31 mmol/g, indicating that it had been partially reduced, i.e., it had accepted 2.48 (=4.79−2.31) mmol/g of electrons during acetate oxidation. This value of “extra” electrons agrees with that (2.24 mmol/g) associated with the observed decrease in ¹³CH₄ and the increase in ¹³CO₂. This value also closely matches the electrons associated with the CH₄ decrease and the CO₂ increase in the sludge incubation experiment (FIGS. 2A-2C). These results thus support that (1) the total ESC of this SRB was constant and that (2) as an electron acceptor, oxidized SRB could divert 2.2-2.5 mmol/g of electrons away from methanogenesis, preventing formation of ca. 0.3 mmol of CH₄ per gram of SRB. This capacity appears to be constant in our experiments, regardless of whether the electron donor was acetate or mixed substrates in the sludge. However, if the microbially usable portion of the ESC is thermodynamically controlled (discussed below), the capacity to prevent CH₄ formation should vary with the electron donor, i.e., a higher percentage of the ESC should become available when a thermodynamically stronger electron donor is utilized.

To assess how the portion of microbially usable ESC was controlled, we performed thermodynamic calculations to estimate the reduction potential of the hypothetical quinone group in SRB that, when serving as an electron acceptor, would render acetate oxidation equally favorable to acetoclastic methanogenesis near the end of the acetate incubation experiment. Our calculations yielded a threshold potential of +0.173 V vs SHE, above which acetate oxidation would be thermodynamically more favorable than methanogenesis. This result suggests that the reason why only ~50% of the total ESC (4.79 mmol/g) was utilized by the sludge culture is that for only half of the ESC (the half with an EH >0.173 V) was acetate oxidation more favorable than fermentation. Once this portion of the ESC was depleted, methanogenesis would commence.

Thus, as referenced herein, an availability factor may be used for calculating an amount of ESC typically available for biological reaction, based upon an amount of ESC present in the PC/BC used for treatment. This availability factor may be in a range of 40-60%, typically 50%, but not limited to any particular value. A 50% assumption, however, is generally conservative. Thus, the calculation of ESC in mmol/g may be divided by 2 to determine an amount of bio-available ESC, and then divided by 8 or multiplied by 0.125 (for 8 electrons transferred to the BC/PC from the acetate per methane molecule avoided) to determine the amount of methane reduction in mmol/g of BC added to the anaerobic ecosystem. So, in embodiments, a treatment amount may be calculated as:

$$A * 0.125 * ESC * M = mmol methane reduction ,$$

$$Where$$

$$A = availability factor in \% ( typically 50 \% )$$

$$ESC = mmol of electrons per gram of biochar$$

$$M = grams of biochar$$

Thus, as noted above, for a total measured ESC of ~ (4.79 mmol/g) for the exemplary biochar discussed above:
0.5*0.125*4.79=0.3 mmol methane reduction per gram of biochar per redox cycle (i.e., without regeneration via exposure of biochar to air)

Additional factors may be applied to account for transport losses during application of the BC and due to depletion (from non-regeneration) or transport over time.

Finally, to assess whether the ability of BC to suppress CH₄ production was unique to SRB, another type of wood char (Rogue biochar, White City, OR) produced by gasification was used for the acetate incubation experiment, giving similar results to those obtained and shown in FIGS. 3A-3D: acetate was fermented to CH₄ and CO₂ in the absence of biochar, whereas CH₄ was completely suppressed by 1.0 g of oxidized Rogue biochar and CO₂ was the only gas product throughout the incubation. This result suggests that the ability to support anaerobic respiration and suppress methanogenesis may be common to wood-based BC. We previously showed that pyrogenic BC derived from plants and plant polymers, including commercial biochars, laboratory-prepared chars, field-aged chars, and wildfire chars, all possessed sizable ESCs. It is perceivable that all BC possessing ESC can alter microbial GHG composition and hence the climate through the same mechanism as discussed herein.

The bacterium G. metallireducens was reported to utilize only ~22% of the total ESC of SRB (same size fraction, 250-500 μm). The much larger percentage of the ESC utilized in this work suggests that the mixed culture was able to access a larger portion of the redox-labile functional groups (i.e., ESC sites), potentially including those residing in the interior pores of SRB particles. This most likely occurred through the actions of molecular electron shuttles such as flavins, quinones, and/or dissolved organic matter that were either present in the sludge or excreted by the microbes. Through pore diffusion, these redox mediators could provide microbes access to the EAC residing in the inner pores of SRB, similar to how they enable microbes to indirectly respire distant solids such as iron and manganese oxides.

While prior studies have suggested that biochar may affect GHG production, the results have been inconsistent or qualitative at best. By contrast, aspects of the present invention establish mechanism that can be harnessed in engineered systems for reducing methane emissions. Deficiencies in the prior art were remedied by the inventors (1) ESC/EAC measurements before and after the experiment to establish electron balance, (2) use of 13C-labeled acetate to obtain carbon balance and (3) control of the total EAC in each experiment. As a result, aspects of the invention allow quantification of the mass of CH₄ diverted per unit mass of BC per redox cycle. The results also show that CH₄ suppression can be attributed to a single mechanism: reversible exchange and storage of electrons in biochar through reactions of its redox functional groups (i.e., ESC). Electrons are transferred with protons (see eq. 8b), and hence, electron storage does not involve charge accumulation. Capacitive or conductive mechanisms are unlikely as low-temperature plant-based chars are poor electrical conductors and do not accumulate charge like capacitors do.

Environmental Implications. As noted above, degradation of organic carbon in anaerobic environments leads to the production of two major GHGs, CO₂ and CH₄, collectively contributing to the majority of anthropogenic warming. Due to its high GWP and short atmospheric lifetime, CH₄exerts an outsized impact on the climate, particularly in the near and medium terms. Aspects of the invention demonstrated the ability of BC to prevent microbial CH₄ production and determined the capacity of a wood biochar (0.3 mmol of CH₄/g) to do so. Using this capacity and the GWP of CH₄ (27.0 and 79.7 over 100 and 20 years, respectively), the potential effect of SRB to reduce global warming can be calculated and expressed as CO₂ equivalent (CO2e) using eq. 9:

$$\text{?} \qquad [ Eq . 9 ]$$

$$\text{?} \text{indicates text missing or illegible when filed}$$

where mCO₂ and mCH₄ are the masses of CO₂ and CH₄ produced in each experiment and CO₂e is the mass of CO₂ that would cause the same extent of warming as mCO and mCH.

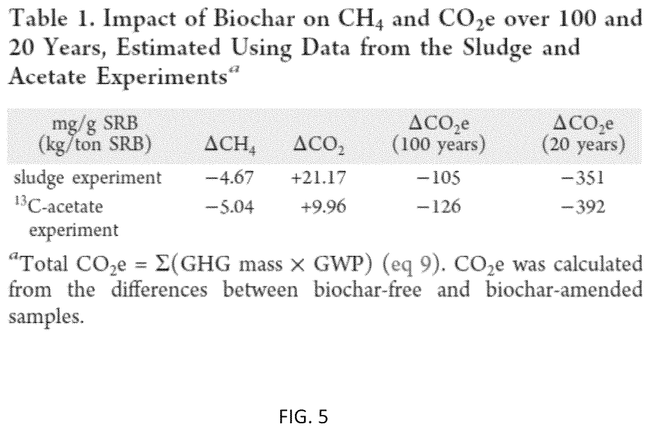

As shown in Table 1 (FIG. 5), up to 5.04 kg of CH₄ production may be prevented per ton of SRB based on the acetate experiment. This translates to a reduction of 126 and 392 kg of CO₂e per ton of SRB over a 100 and 20 year time frame, respectively.

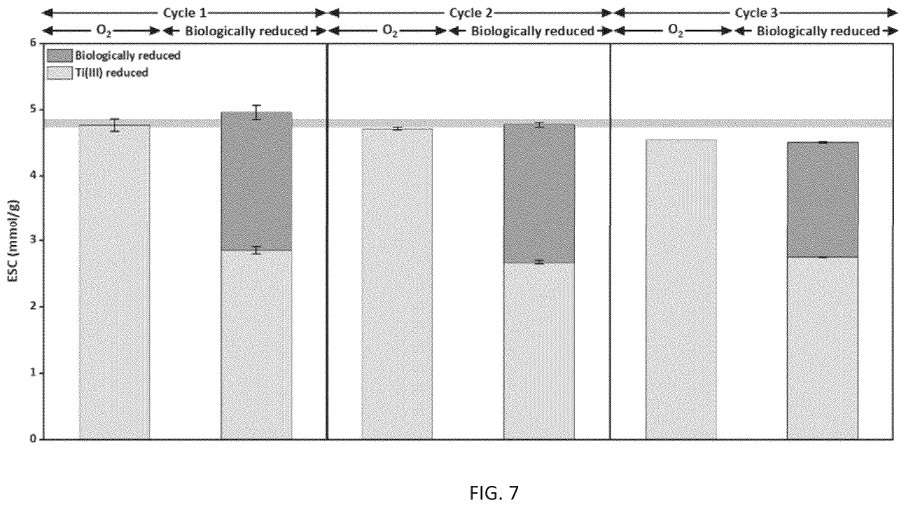

Given that wildfires and deforestation convert up to 27% of the biomass into BC and produce >100 Tg of BC annually, the amount of CH₄ prevented by BC could be as high as 0.5 million tons per year. This calculation, while preliminary, suggests that the impact of BC as an electron acceptor on the composition of global GHG emitted from microbial sources could be significant. In addition, this calculation considers the effect in only one redox cycle. Previous studies have shown that the EAC of BC is highly regenerable by dissolved O₂ over multiple redox cycles. In environments of oscillating redox potential (e.g., wetlands, tidal marshes, rice paddies, etc.), CH₄ suppression by BC may occur continually over repeated redox cycles through periodic regeneration of the EAC by O₂, potentially magnifying the cumulative impact of BC's ESC on the climate. For example, FIG. 7 depicts successive cycles wherein the left column for each cycle shows constant, fully regenerable ESC, and the right column for each cycle shows biological utilization of approximately half the ESC during the cycle. The slight decrease in biologically utilized ESC in each successive cycle is due to losses (incomplete recovery) of BC from cycle to cycle.

Likewise, in natural cyclical systems, such as tidal marshes, areas treated with BC may suffer decreases in methane reduction over time due to erosive losses of BC and transport of the BC out of the active ecosystem (or permanent submersion of BC that eliminates or reduces exposure to air at low tide and minimizes regeneration of the bioavailable ESC), which may require replenishment over time. Application to wetlands may also comprise, for example, application from air (e.g. from a crop dusting plane), which may experience airborne losses. Accordingly, treatment amounts as discussed herein generally refer to a minimum treatment amount, and it should be understood that overtreatment is unlikely to have a negative impact on the ecosystem (except increased cost of treatment). Therefore, treatment amounts may include not only factors to account for bioavailability of the ESC, but also losses due to application methods and losses due to transport or depletion of effectiveness over time, which factors may comprise multipliers for calculating a treatment amount per amount of methane to be reduced. Losses due to transport over time may be used for calculating replenishment amounts per unit time and an overtreatment factor for first time treatment, based upon an expected time before a replenishment.

When the anaerobic ecosystem is disposed in an area of land, such as but not limited to a wetland, tidal marsh, or rice paddy, the treatment methods may include estimating a unit mass of the anaerobic ecosystem per unit surface area of the area of land, calculating the mass ratio of BC to be applied per unit surface area of the area of land, and applying the quantity of BC to the surface area of the of the area of land. The unit mass per surface area can be determined by spot techniques of isolating one or more soil samples having a predetermined volume corresponding to a predetermined surface area and determining an average mass of methane likely to be released per unit of surface area based upon the information determined about the sample, such as the amount of bioavailable matter in the sample prone to conversion into methane, and the amount of methane expected to be produced per unit area without treatment. The full area of the land to be treated can be determined from surveys or aerial (e.g. airplane, satellite, drone) imaging, depending on the size of the land. The calculated quantity of BC can then be dispersed using an arial dispersion technique (e.g., crop duster or drone). For less environmentally sensitive lands where the use of land machines is practical and not disruptive, the dispersion may be performed by standard agricultural machinery known in the art for surface treatment of land. Aspects of the invention are not limited to any particular methods of application.

In addition to the mechanistic explanation and climate implications, this study also provides data for developing potential ESC-based applications for mitigating biogenic CH₄ emissions from natural and anthropogenic sources. A persistent form of carbon, BC such as biochar made from surplus biomass has been proposed as a means to sequester carbon in soil and sediment. If engineered properly, BC may also offer the additional benefit of cutting CH₄ emissions. A BC-based technology that includes both carbon stabilization/storage and CH₄ reduction may represent an economically attractive approach to offset carbon emissions or generate carbon credit.

Finally, if BC represents a large, ubiquitous, rechargeable, and microbially accessible electron reservoir, it may affect not only CH₄ but potentially other biogenic GHG, such as nitrous oxide (N₂O). While many studies have tested the effects of BC on nitrification and denitrification, the role of ESC was never considered or understood. Similar to how SRB shifted the electron flow through the sludge microbial community, BC may influence the nitrification and/or denitrification cycles in soil and sediment through its ESC. Given that BC is abundantly produced and ubiquitous, and that ESC is a universal property of plant-based BC, the role and impacts of BC on climate, contaminant fate, biogeochemistry, and other areas of environmental science and engineering need to be better understood. This is particularly vital, given that wildfires are projected to increase in frequency, duration, and intensity in the foreseeable future.

Although the invention is illustrated and described herein with reference to specific embodiments, the invention is not intended to be limited to the details shown. Rather, various modifications may be made in the details within the scope and range of equivalents of the claims and without departing from the invention.

1. A method for reducing an amount of methane emitted from an anaerobic ecosystem comprising a microbial source prone to methanogenesis, the method comprising adding at least an effective quantity of pyrogenic carbon (PC) as a terminal electron acceptor to promote anaerobic respiration and suppress methanogenesis, the effective quantity comprising a ratio of unit weight of PC for each mmol of CH₄ otherwise expected to be produced and desired to be reduced from the anaerobic ecosystem per treatment (redox) cycle, wherein the ratio is based upon an electron storage capacity (ESC) of the PC and is calculated as:
$$A * 0.125 * ESC * M = mmol methane reduction , wherein :$$
$$A = ESC bioavailability factor ( unitless ) ;$$
$$ESC = measured ESC in mmol / unit weight of PC$$
$$M = weight of PC .$$

2. The method of claim 1, wherein the PC comprises a biochar (BC).

3. The method of claim 2, wherein the BC comprises a plant based biochar.

4. The method of claim 3, wherein the BC comprises a wildfire char.

5. The method of claim 1, wherein the anaerobic ecosystem comprises a wastewater or sludge treatment facility.

6. The method of claim 1, wherein the anaerobic ecosystem comprises an animal waste management system.

7. The method of claim 1, wherein the anaerobic ecosystem comprises a landfill.

8. The method of claim 1, wherein the anaerobic ecosystem comprises a rice paddy.

9. The method of claim 1, wherein the anaerobic ecosystem comprises a wetland.

10. The method of claim 9, wherein the anaerobic ecosystem cyclically alternates between the PC being exposed to air and being submerged, wherein the PC suppresses methane formation through its electron storage capacity when submerged and regains that capacity when exposed to air.

11. The method of claim 1, wherein the anaerobic ecosystem comprises a tidal marsh.

12. A method for reducing an amount of methane emitted from an anaerobic ecosystem comprising a microbial source prone to methanogenesis, the method comprising the steps of:
a) determining an expected amount of CH4 generated per unit mass of the anaerobic ecosystem;
b) providing a source of biochar (BC);
c) determining an electron storage capacity (ESC) in mols of ESC of the BC and an availability of the biochar;
d) based upon the ESC and availability (A) of the BC, determining a mass ratio of BC to be added per unit mass of the anaerobic ecosystem as a terminal electron acceptor to achieve a desired percentage reduction in the expected amount of CH4 generated per unit mass of the anaerobic ecosystem, the mass ratio comprising A*0.125*ESC*M per mmol methane reduction per redox cycle, wherein:
$$A = ESC bioavailability factor ;$$
$$ESC = electron storage capacity in mmol / unit weight of BC ;$$
$$M = weight of BC ;$$
e) treating the anaerobic ecosystem with a quantity of the BC in at least the determined mass ratio.

13. The method of claim 12, wherein A=40-60%.

14. The method of claim 12, wherein the BC comprises a plant based biochar.

15. The method of claim 12, wherein the anaerobic ecosystem comprises natural system selected from the group consisting of a wetland and tidal marsh.

16. (canceled)

17. The method of claim 12, wherein the anaerobic ecosystem comprises an agricultural system selected from the group consisting of an animal waste management system and a rice paddy.

18. (canceled)

19. (canceled)

20. The method of claim 12, wherein the anaerobic ecosystem comprises an engineered system comprising a landfill.

21. (canceled)

22. The method of claim 12, wherein the anaerobic ecosystem cyclically alternates between the PC being exposed to air and being submerged, wherein the PC loses electron storage capacity (ESC) when submerged and regains ESC when exposed to the air.

23. (canceled)

24. The method of claim 13 comprising awarding a carbon credit for greenhouse gas (GHS) reduction based upon carbon sequestration of the BC as well as methane avoidance.

25. The method of claim 13, wherein the anaerobic ecosystem is disposed in an area of land selected from the group consisting of: a wetland, a tidal marsh, and a rice paddy, and the method comprises estimating a unit mass of the anaerobic ecosystem per unit surface area of the area of land, calculating the mass ratio of BC to be applied per unit surface area of the area of land, and applying the quantity of BC to the surface area of the of the area of land using an arial dispersion technique.

26. (canceled)

27. (canceled)
